(19) United States
(12) Patent Application Publication
(10) Pub. No.: US 2014/0054486 A1
(43) Pub. Date: Feb. 27, 2014

(54) FLOW CONTROL VALVE

(71) Applicant: AISAN KOGYO KABUSHIKI KAISHA, Obu-shi (JP)

(72) Inventors: Hiroshi FUJIKI, Kariya-shi (JP); Takashi MASUDA, Toyota-shi (JP)

(73) Assignee: AISAN KOGYO KABUSHIKI KAISHA, Obu-shi (JP)

(21) Appl. No.: 13/963,918

(22) Filed: Aug. 9, 2013

(30) Foreign Application Priority Data
Aug. 22, 2012 (JP) 2012-183066

(51) Int. Cl. F16K 21/04

(52) U.S. Cl. CPC F16K 21/04
USPC 251/321

(57) ABSTRACT

Certain embodiments of the disclosure are directed towards flow control valves having a casing having an inlet and an outlet, a valve body housed in the casing where it is movable in an axial direction, and a coil spring biasing the valve body toward the inlet wherein the casing has a measuring portion therein. The valve body has at its outer circumference of a front end a measuring surface to be inserted into the measuring portion. The measuring surface of the valve body has a small-diameter surface portion at a front end side, a large-diameter surface portion at a base end side and a tapering surface portion connecting the small-diameter surface portion with the large-diameter surface portion. The valve body moves depending on pressure differences between an inlet side and an outlet side in order to control a flow rate of a fluid flowing through a space between the measuring-portion of the casing and the measuring surface of the valve body. A spring constant of the coil spring has non-linear characteristics becoming larger in a stepped manner or a continuous manner in accordance with an increase of the compression amount.

This application claims priority to Japanese patent application serial number 2012-183066, the contents of which are incorporated herein by reference.

### BACKGROUND OF THE INVENTION

This disclosure relate to a flow control valve for controlling the amount of a fluid flowing therethrough.

### BRIEF SUMMARY OF THE INVENTION

For example, a positive crankcase ventilation (PCV) valve is used as a flow control valve for controlling the flow amount of blow-by gas in a blow-by gas reducing device of an internal combustion engine (engine) for a vehicle such as automobile (see Japanese Laid-Open Patent Publication No. 2005-330898). A common PCV valve will be described. FIG. 16 is a cross-sectional view of the common PCV valve.

As shown in FIG. 16, a PCV valve 100 has a hollow cylindrical case 102 having an inlet and an outlet, a valve body 104 disposed in the case 102 reciprocably in an axial direction, and a coil spring 106 biasing the valve body 104 toward the inlet (rightward in FIG. 16). The case 102 has a large-diameter portion 108 having a larger inner diameter, a small-diameter portion 109 that has a smaller diameter and is positioned downstream of the large-diameter portion 108 with respect to a flow direction of PCV gas (left side in FIG. 16), and a step portion 110 connecting the large-diameter portion 108 with the small-diameter portion 109. The small-diameter portion 109 has a measuring portion (measuring hole) 112 having a predetermined inner diameter. A measuring surface 114 that is composed, of an outer circumference to be inserted into the measuring portion 112 of the case 102 is provided on the valve body 104. The measuring surface 114 of the valve body 104 concentrically has a tapering surface 117 such that its diameter gradually increases from a small-diameter side toward a large-diameter side between a small-diameter surface portion 115 near a tip end side and a large-diameter surface portion 116 near a base end side. The valve body 104 has a flange 119 at its base end portion. The coil spring 106 is located between the step portion 110 of the case 102 and the flange 119 of the valve body 104. When negative suction pressure of the internal combustion engine is applied into the case 102, the valve body 104 moves toward the outlet (leftward in FIG. 16) against the biasing force of the coil spring 106 in accordance with the negative suction pressure (boost pressure) in the PCV valve 100. Thus, the amount of blow-by gas flowing through a ring-shaped space 121 between the measuring portion 112 of the case 102 and the measuring surface 114 of the valve body 104 is controlled, i.e., is measured.

The coil spring 106 of the PCV valve 100 is a cylinder-shaped regular pitch coil spring that has a fixed spring constant. Thus, there is a possibility that single characteristic vibration (resonance frequency) or mass-spring system matches up with specific frequency such as engine vibration or induction pulsation, causing sympathetic vibration between the valve body 104 and the coil spring 106. Accordingly, there has been a need for improved flow control valves.

One aspect of this disclosure is a flow control valve having a casing with an inlet and an outlet a valve body housed in the casing movable in an axial direction. A coil spring may bias the valve body toward the inlet wherein the casing has a measuring portion therein. The valve body has at its outer circumference a front end of a measuring surface to be inserted into the measuring portion. The measuring surface of the valve body has a small-diameter surface portion at a front end side, a large-diameter surface portion at a base end side and a tapering surface portion connecting the small-diameter surface portion with the large-diameter surface portion. The valve body moves in accordance with the pressure difference between an inlet side and an outlet side in order to control a flow rate of a fluid flowing through a space between the measuring portion of the casing and the measuring surface of the valve body. A spring constant of the coil spring has non-linear characteristics which becomes larger in a stepped manner or a continuous manner depending on the increase of the compression amount.

In accordance with this aspect, since the coil spring has non-liner characteristics whose spring constant becomes larger in a stepped or continuous manner, the natural frequency of mass-spring system changes depending on compression of the spring. Thus, it is able to prevent sympathetic vibration of the mass-spring system with specific frequency such as engine vibration or suction pulsation. This is effective for the deterioration of flow rate character or prevention of abnormal abrasion of a sliding portion.

### BRIEF DESCRIPTION OF THE DRAWINGS

FIG. 1 is a cross-sectional view of a PCV valve according to a first embodiment;

FIG. 2 is a side view of a valve body;

FIG. 3 is a side view of a cylinder-shaped two-phased pitch coil spring;

FIG. 4 is a graph showing a relationship between a boost pressure of a PCV valve and a movement stroke of a valve body;

FIG. 5 is a schematic view of a blow-by gas reducing device;

FIG. 6 is a cross-sectional view showing a part of a PCV valve according to comparative example 1;

FIG. 7 is a graph showing a relationship between a boost pressure of a PCV valve and a movement stroke of a valve body;

FIG. 8 is a cross-sectional view showing a part of a PCV valve according to comparative example 2;

FIG. 9 is a graph showing a relationship between a boost pressure of a PCV valve and a movement stroke of a valve body;

FIG. 10 is a cross-sectional view of a PCV valve according to a second embodiment;

FIG. 11 is a side view of an hourglass-shaped coil spring;

FIG. 12 is a cross-sectional view of a PCV valve according to a third embodiment;

FIG. 13 is a side view of a barrel-shaped coil spring;

FIG. 14 is a cross-sectional view of a PCV valve according to a fourth embodiment;

FIG. 15 is a side view of a coil spring having a gradually changing cylinder-shaped pitch;

FIG. 16 is a cross-sectional view of a common PCV valve.

### DETAILED DESCRIPTION OF THE INVENTION

Each of the additional features and teachings disclosed above and below may be utilized separately or in conjunction with other features and teachings to provide improved flow control valves. Representative examples of the present invention, which examples utilized many of these additional features and teachings both separately and in conjunction with one another, will now be described in detail with reference to the attached drawings. This detailed description is merely intended to teach a person of skilled, in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

A first embodiment will be described. In this embodiment, a PCV valve used in a blow-by gas-reducing device for an internal combustion engine is exemplified as a flow control valve. For convenience of explanation, the blow-by gas-reducing device will be described before the PCV valve. Here, FIG. 5 is a schematic view of the blow-by gas-reducing device. As shown in FIG. 5, a blow-by gas-reducing device 10 is a system where the blow-by gas that leaks into a crankcase 15 of a cylinder block 14 from a combustion chamber of an engine body 13 of an internal combustion engine 12 is introduced into an intake manifold 20 in order to re-burn it in the combustion chamber.

The engine body 13 has the cylinder block 14, an oil pan 16 engaged with a lower surface of the crankcase 15, a cylinder head 17 engaged with an upper surface of the cylinder block 14, and a cylinder head cover 18 engaged with an upper surface of the cylinder head 17. The engine body 13 obtains driving force through steps such as induction, compression, ignition, and emission. When burning occurs in the combustion chamber (not shown) of the engine body 13, blow-by gas is generated in the engine body 13, i.e., in the crankcase 15 or in the cylinder head cover 18 communicated with the crankcase 15. Here, the cylinder head cover 18 and the crankcase 15 corresponds to the inside of the engine into which the blow-by gas flows.

The cylinder head cover 18 has a new air inlet 18a and a blow-by gas outlet 18b. The new air inlet 18a is connected, with one end (lower end) of a new air induction pathway 30. And, the blow-by gas outlet 18b is connected with one end (upper end) of a blow-by gas pathway 36. Here, the new air inlet 18a and/or the blow-by gas outlet 18b can be provided on the crankcase 15 instead of cylinder head cover 18.

The cylinder head 17 communicates with one end (downstream end) of the intake manifold 20. The intake manifold 20 has a surge tank 21. Another end (upstream end) of the intake manifold 20 communicates with an air cleaner 25 via a throttle body 24 and an induction pipe 23. The throttle body 24 has a throttle valve 24a. The throttle valve 24a is connected to e.g., an accelerator (not shown) and is opened and closed depending on the operation level of the accelerator. The air cleaner 25 is configured to introduce air, i.e., new air, and has a filter element 26 therein for filtering the new air. The air cleaner 25, the induction pipe 23, the throttle body 24 and the intake manifold 20 form an induction pathway 27 for introducing new air, i.e., induction air info the combustion chamber of the engine body 13. In the induction pathway 27, the pathway upstream of the throttle valve 24a is referred to as the upstream air induction pathway 27a, and the pathway downstream of the throttle valve 24a is referred to as the downstream air induction pathway 27b.

A new air inlet 29 is provided at the induction pipe 23. The new air inlet 29 is connected, with another end (upstream end) of the new air induction pathway 30. The air induction pathway 30 is provided with a check valve 32. The check valve 32 allows air, i.e., new air to flow from the upstream air induction pathway 27a into the crankcase 15 (see arrow Y1 in FIG. 5), and. prevents flow in an opposite direction (see arrow Y3 in FIG. 5.) A blow-by gas inlet 34 may be formed on the surge tank 21. The blow-by gas inlet 34 is connected, with another end (downstream end) of the blow-by gas pathway 36. Here, the check valve 32 may provided or it can be omitted.

Next, an operation of the blow-by gas-reducing device 10 will be described. Under a low or middle-load condition of the internal combustion engine 12, the throttle valve 24a is substantially completely closed. Thus, a larger negative suction pressure (negative suction pressure toward vacuum) is generated in the downstream air induction pathway 27b of the induction pathway 27 as compared to the upstream air induction pathway 27a. Thus, the blow-by gas in the engine body 13 is introduced into the downstream air induction pathway 27b through the blow-by gas pathway 36 (see arrow Y2 in FIG. 5). Under this condition, the amount of the blow-by gas flowing through the blow-by gas pathway 36 is controlled by a PCV valve 40.

When the blow-by gas is introduced into the downstream air induction pathway 27b through the blow-by gas pathway 36 from the engine body 13, the check valve 32 is opened. Thus, new air in the upstream air induction pathway 27a of the induction pathway 27 is introduced into the engine body 13 through the new air induction pathway 30 (see arrow Y1 in FIG. 5). Then, the new air introduced into the engine body 13 is introduced into the downstream air induction pathway 27b through the blow-by gas pathway 36 together with the blow-by gas (see arrow Y2 in FIG. 5). As shown above, an emission operation of the engine body 13 is carried out.

When the internal combustion engine 12 is under a high-load, the opening ratio of the throttle valve 24a becomes larger. Thus, a pressure in the downstream air induction pathway 27b of the induction pathway 27 becomes close to the atmospheric pressure. Accordingly, it is difficult for the blow-by gas in the engine body 13 to be introduced into the downstream air induction pathway 27b. In this way, the pressure in the engine body 13 becomes close to the atmospheric pressure. Thus, the amount of new air flowing from the upstream air induction pathway 27a through the new air induction pathway 30 into the engine body 13 also decreases. And, since the check valve 32 is closed, a counter flow of the blow-by gas from the engine body 13 into the new air induction pathway 30 (see arrow Y3 in FIG. 5) is prevented.

The blow-by gas pathway 36 is provided with the PCV valve 40 as a flow control valve for controlling the flow amount of the blow-by gas. The PCV valve 40 controls, i.e., measures the flow amount of the blow-by gas depending on a pressure difference between an upstream side pressure and a downstream side pressure, i.e., negative suction pressure (also referred to as boost pressure). Thus, it is able to flow the flow amount of the blow-by gas to the downstream air induction pathway 27b depending on the amount of the blow-by gas generated in the internal combustion engine 12.

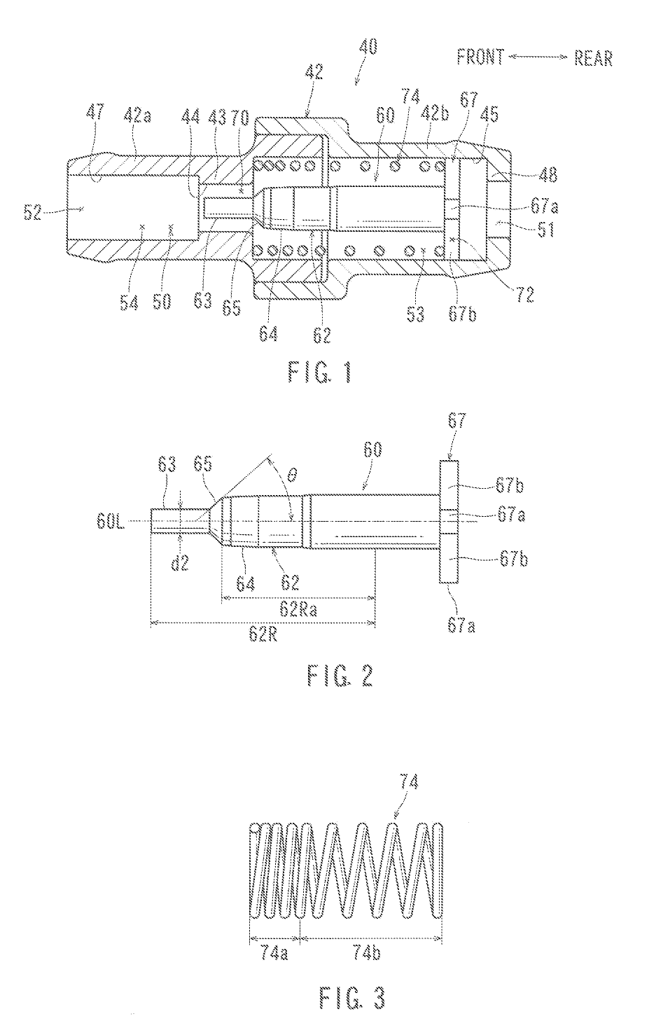

Next, the PCV valve will be described. FIG. 1 is a cross-sectional view of the PCV valve. For convenience of explanation, a left side in FIG. 1 corresponds to a front side, and a right side in FIG. 1 corresponds to a rear side. As shown in FIG. 1, a case 42 of the PCV valve 40 is made from, e.g., resin materials and is formed in a hollow cylindrical shape. A hollow space inside of the case 42 is blow-by gas pathway 50 (gas pathway) extending in an axial direction (horizontal direction in FIG. 1). The case 42 has an inlet 51 of the gas pathway 50 at a rear end (right end in FIG. 1), and has an outlet 52 of the gas pathway 50 at a front end (left end in FIG. 1). The inlet 51 is connected to an upstream end of the blow-by gas pathway 36 (see FIG. 5). The outlet 52 is connected to a downstream end of the blow-by gas pathway 36. Thus, the blow-by gas that is a fluid which flows through the gas pathway 50. In addition, in some case, the inlet 51 can be connected to the blow-by gas outlet 18b of the cylinder head cover 18. Here, the gas pathway 50 corresponds to fluid pathway herein.

The case 42 is formed by a pair of case halves 42a, 42b that are divided in an axial direction (horizontal direction in FIG. 1). The front case half 42a concentrically has at its center region a projecting wall portion 43 that is formed in a hollow cylindrical shape for decreasing its inner diameter. An inward facing surface of the projecting wall portion 43 forms a measuring portion 44 that is shaped in a hollow cylindrical shape. The rear case half 42b, i.e., an inlet side of the gas path 50 (right side in FIG. 1) has an upstream side pathway wall 45 that is formed in a hollow cylindrical shape. On the inside of the upstream side pathway wail 45 is an upstream side pathway 53. The gas outflow side (left side in FIG. 1) of the projecting wail portion 43 of the front case half 42a has a downstream side pathway wall 47 formed in a hollow cylindrical shape. The inside of the downstream side pathway wall 47 is configured as a downstream side pathway 54. At a rear end. of the rear case half 42b, an end wall 48 is concentrically provided in a flange shape such that the end wall 48 projects inwardly from the upstream side pathway wall 45. A hole formed by the end wall 48 corresponds to the inlet 51.

In the case 42, i.e., in the gas pathway 50, a valve body 60 that is made from, e.g., resin materials, is movably located in an axial direction (horizontal direction in FIG 1). FIG 2 is a side view showing the valve body. As shown in FIG. 2, the valve body 60 is formed in a stepped tapering shape. At an outer circumferential surface of an end portion, i.e., front portion of the valve body 60 (left half in FIG. 2), a measuring surface 62 is provided. The measuring surface 62 has a cylinder-shaped small-diameter surface portion 63 at a front end, a cylinder-shaped large-diameter surface portion 64 that is located at a base side and has a larger diameter than the small-diameter surface portion 63. It also has a tapering surface portion gradually increasing its diameter toward, the large-diameter side from the small-diameter side. Here, at the measuring surface 62, stepped surfaces and/or tapering surfaces or the like are between the large-diameter end of the tapering surface portion 65 and the end portion at the base portion. These stepped surfaces and/or tapering surfaces or the like are minute changes and thus are generally ignored. At the rear end of the valve body 60 (right end in FIG. 2), a guide portion 67 formed in a flange shape projecting outwardly in a radial direction is concentrically provided. At the outer circumference of the guide portion 67, a plurality of flat-shaped cutoff surfaces 67b are formed at equal intervals. Surfaces between the cutoff surfaces 67b may correspond to arc-shaped surfaces 67.

As shown in FIG. 1, the valve body 60 is located in the case 42 whereby it can move in the axial direction. The measuring surface 62 of the valve body 60 is loosely fitted in the measuring portion 44 of the case 42. A ring-shaped space 70 is formed between the measuring portion 44 and the measuring surface 62 through which the blow-by gas can pass through. Thus, when the valve body 60 moves forward (leftward in FIG. 1), a path cross-sectional area of the space 70 decreases. Conversely, when the valve body 60 moves backward (rightward in FIG. 1), the path cross-sectional area of the space 70 increases. The measuring surface 62 of the valve body 60 corresponds to the measuring portion 44 in the operational range between the most backward movement position and the most frontward movement position of the valve body 60. In the operational range of the valve body 60, a portion of the measuring surface 62 of the valve body 60 corresponding to the measuring portion 44 is shown in FIG. 2 as 62R. The range of large-diameter surface portion 64 of the measuring surface 62 is shown in FIG. 2 as 62Ra. The arc-shaped surfaces 67a of the guide portion 67 of the valve body 60 are engaged with the upstream side pathway wail 45 of the case 42 in a slidable manner. Between the upstream side pathway wall 45 and the cutoff surfaces of the guide portion 67, D-shaped spaces where the blow-by gas flows are formed.

As shown in FIG. 1, a coil spring 74 is located between the case 42 and the valve body 60. In detail, the coil spring 74 is engaged with the valve body 60, and is located between the projecting wall portion 43 of the case 42 and the guide portion 67 of the valve body 60. The coil spring 74 biases the valve body 60 toward the outlet 51 (rightward in FIG. 1). The coil spring 74 will be described later in detail.

Next, an operation of the PCV valve 40 (see FIG. 1) will be described. When the internal combustion engine 12 is stopped, negative suction pressure (boost pressure) is not generated in the induction pathway 27 (see FIG. 5), and thus the valve 60 is biased by the coil spring 74 such that the guide portion 67 contacts the end wall 48 of the case 42 (full open condition). On the other hand, when the engine 12 is running, the negative suction pressure of the induction pathway is applied to the gas pathway 50 of the case 42 through the outlet 52, so that the negative suction pressure moves the valve body 60 toward the outlet 52 against biasing force of the coil spring 74.

When the internal combustion engine 12 is in a low-load condition, the opening ratio of the throttle valve 24a (see FIG. 5) is small and the negative suction pressure generated in the induction pathway 27 is high, so that the valve body 60 is moved forward. Thus, the path cross-sectional area of the space 70 between the measuring portion 44 of the case 42 and the measuring surface 62 of the valve body 60 becomes minimal or substantially minimal, so that the amount of the blow-by gas flowing through the gas pathway 50 decreases. When the engine 12 is in a middle-load condition, the opening ratio of the throttle valve 24a is high and negative suction pressure generated in the induction pathway 27 becomes low, so that the valve body 60 is moved rearward by the coil spring 74. Thus, the path cross-sectional area of the space 70 between the measuring portion 44 of the case 42 and the measuring surface 62 of the valve body 60 becomes large, so that the amount of blow-by gas flowing the gas path 50 is larger than that in a condition that the engine 12 is in the low-load condition. When the engine 12 is under a high-load condition, the opening ratio of the throttle valve 24a becomes opened to its maximum amount or substantially its maximum amount, and there is substantially no negative suction pressure generating in the induction pathway 27, so that the coil spring 74 moves the valve body 60 to the furthest backward movement position (full opening) or a position close to the farthest backward movement position. Thus, the path cross-sectional area of the space 70 between the measuring portion 44 of the case 42 and the measuring surface 62 of the valve body 60 becomes its maximum or substantially its maximum, so that the amount of the blow-by gas flowing through the gas path 50 is greater than that in the middle-load condition.

Next, the coil spring 74 will be described in detail. FIG. 3 is a side view of a cylinder-shaped two-phased pitch coil spring. As shown in FIG. 3, the coil spring 74 is a cylinder-shaped irregular pitch coil spring having a non-linear character where the spring constant increases in a step manner in accordance with an increase in compression. In detail, the coil spring 74 is configured to have a first region 74a and a second region 74b having a longer pitch of winding wire than the first region 74a. That is, the spring constant of the first region 74a is smaller than that of the second region 74b. The first region 74a corresponds to the movement stroke of an end side containing the small-diameter surface portion 63 of the measuring surface 62 of the valve body 60 and tapering surface portion 65 against the measuring portion 44 of the case 42. The coil spring 74 is located in the case 42 such that the first region 74a is positioned, at the front and the second region 74b is positioned at the rear (see FIG. 1). Thus, the blow-by gas is able to flow between the wires of the coil spring 74.

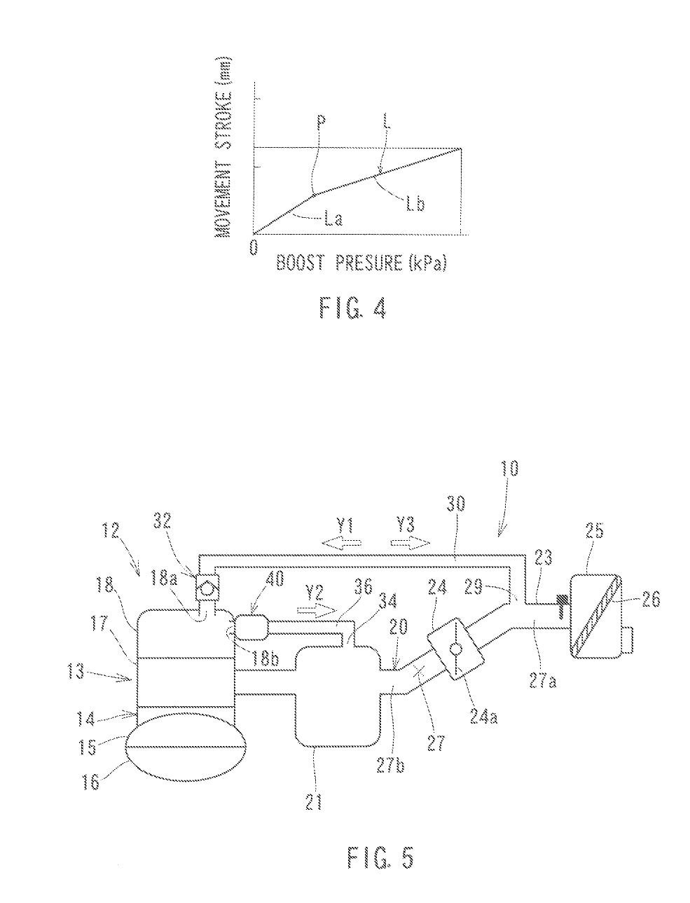

FIG. 4 is a graph showing a relationship between a boost pressure of the PCV valve and a movement stroke of the valve body. As shown in FIG. 4, a characteristic line L has a changing point P. The movement stroke of the valve body 60 of the characteristic line La per unit pressure when the boost pressure (negative suction pressure) is below the changing point P is greater than that of the valve body 60 of the characteristic line Lb per unit pressure when the boost pressure is equal to or above the changing point P. That is, when the cylinder-shaped two-phased, pitch coil spring 74 of the PCV valve 40 (see FIG. 1) is compressed from a full opening state of the PCV valve 40, it elastically deforms such that the pitch of the first region 74a mainly decreases while generating a repulsion force that is determined based on the movement stroke of the valve body 60 and the spring constant of the first region 74a (see the characteristic line La in FIG. 4). When the cylinder-shaped two-phased pitch coil spring 74 is further compressed, adjacent wires in the first region 74a contact each other (see the changing point P in FIG. 4). When the spring 74 is compressed further, the second region 74b is compressed, and it generates a repulsion force that is determined based on the movement stroke of the valve body 60 and the spring constant of the second region 74b (see the characteristic line Lb).

In accordance with the PCV valve 40 (see FIG. 1), the coil spring 74 is composed of a cylinder-shaped two-phased pitch coil spring (cylinder-shaped irregular pitch coil spring) that has a spring constant increasing in a stepped manner in accordance with the amount of compression. Thus, as the coil spring 74 is compressed, natural frequencies of mass-spring system (the valve body 60 and the coil spring 74) change. Thus, it is able to prevent sympathetic vibration of the mass-spring system at a specific frequency such as engine vibration or admission pulsation. This is effective for the prevention of deterioration of flow rate characteristics and abnormal abrasion of sliding portions.

The cylinder-shaped two-phased pitch coil spring 74 has two-stage non-linear characteristics. The first region 74a having smaller spring constant of the coil spring 74 (see FIG. 3) corresponds to movement stroke of the end side containing the small-diameter surface portion 63 of the measuring surface 62 of the valve body 60 and the tapering surface portion 65 against the measuring portion 44 of the case 42. Thus, the movement stroke of the valve body 60 per unit pressure at the first region 74a of the smaller spring constant of the coil spring 74 can be increased more than the movement stroke of the valve body 60 per unit pressure at the remaining region of the corresponding second, region 74b. Thus, while loosening a tapering angle (see FIG. 2) of the tapering surface portion 65 of the measuring surface 62 of the valve body 60, the minimum flow amount can be increased (outer diameter d2 of the small-diameter surface portion 63 is decreased). In this way, an axial length of the large-diameter surface portion 64 (see a range 62Ra in FIG. 2) of the measuring surface 62 of the valve body 60 can be shortened. Here, the tapering angle θ is the angle between an axial line 60L of the valve body 60 and the tapering surface portion 65.

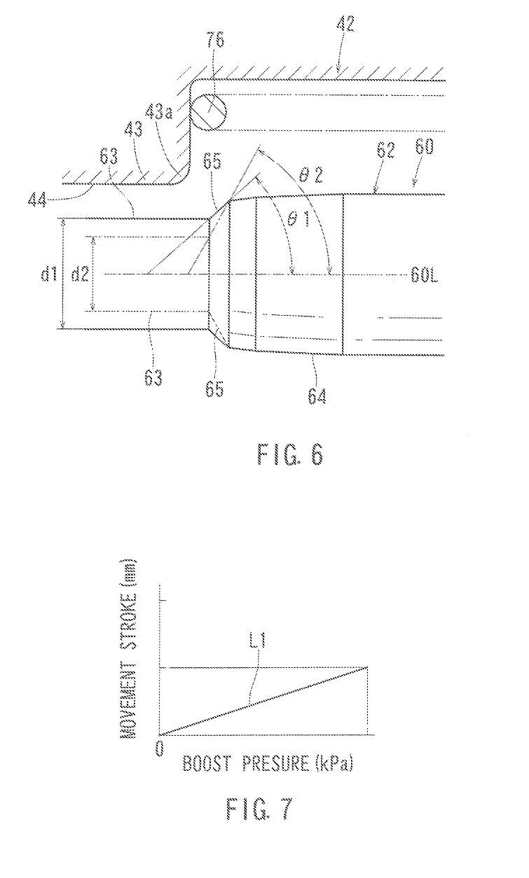

Next, comparative examples 1 and 2 will be described. FIG. 6 is a cross-sectional view of a part of a PCV valve according to a comparative example 1. FIG. 7 is a graph showing the relationship between a movement stroke of a valve body and a boost pressure of the PCV valve. In the first comparative example 1, a cylinder-shaped regular pitch coil spring 76 that is shown by a characteristic line L1 in FIG. 7 is used for the coil spring of PCV valve 40 as shown in FIG. 6. The cylinder-shaped regular pitch coil spring 76 has a fixed spring constant. In this case, a taper angle of the tapering surface portion 65 of the measuring surface 62 of the valve body 60 is defined as θ1. An outer diameter of the small-diameter surface portion 63 of the measuring surface 62 of the valve body 60 is defined as d1. In a state that the engine is under high-load condition, i.e., a full throttle condition of the accelerator and the valve body 60 is at its maximum opening or substantially maximum opening, if the operator would like to increase the flow amount of the blow-by gas, the outer diameter d1 of the small-diameter surface portion 63 of the measuring surface 62 of the valve body 60 is decreased to an outer diameter 62. Then, the tapering angle θ1 becomes large one θ2, i.e., it becomes sharp. Thus, when the valve body 60 vibrates such that the tapering surface portion 65 of the valve body 60 contacts a corner 43a of the projecting wall portion 43 of the case 42, there is a risk of operation and anti-wear property of the valve body 60. Here, two-dot chain line 63 shows the small-diameter surface portion 63 of the outer diameter d2, and two-dot chain line 65 shows the tapering surface portion 65 of the taper angle θ2.

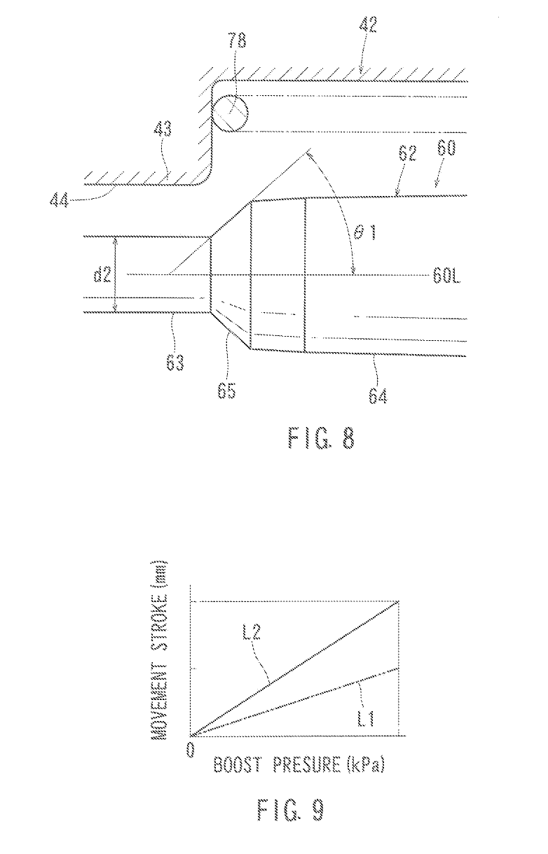

FIG. 8 is a cross-sectional view showing a part of the PCV valve of comparative example 2. FIG. 9 is a graph showing the relationship between the boost pressure of the PCV valve and the movement stroke of the valve body. In the comparative example 2, a cylinder-shaped regular pitch coil spring 78 that has a characteristic line L2 in FIG. 9 is used for the coil spring of the PCV valve 40. FIG. 8 shows the characteristic line L1 of the cylinder-shaped regular pitch coil spring 76 of the comparative example 1. The cylinder-shaped regular pitch coil spring 78 has a fixed spring constant smaller than the cylinder-shaped regular pitch coil spring 76 of the comparative example 1. For example, when the spring constant of the cylinder-shape regular pitch coil spring 78 is set at half of the spring constant of the cylinder-shaped regular pitch coil spring 76, movement stroke of the valve body 60 becomes twice as long as the movement stroke of the valve body 60 of the comparative example 1. Thus, the outer diameter of the small-diameter surface portion 63 of the measuring surface 62 to d2 is able to decrease while keeping the taper angle of the tapering surface portion 65 of the measuring surface 62 of the valve body 60 same as the taper angle θ1 (see FIG. 8). However, an axial length of the large-diameter surface portion 64 of the measuring surface 62 of the valve body 60 becomes longer, so that the PCV 40 grows in size and gains weight, and it would become difficult to mount the PCV valve 40 on the internal combustion engine 12.

In the PCV valve 40 of this embodiment, the cylinder-shaped two-phased pitch coil spring 74 having the characteristic line L in FIG. 4 is used as a spring. That is, the characteristic line La of the characteristic line L is same as the characteristic line L2 (see FIG. 9) of the cylinder-shaped regular pitch coil spring 78 (see FIG. 8) of the comparative example 2. The characteristic line Lb is same as the characteristic line L1 (see FIG. 7) of the cylinder-shaped regular pitch coil spring 76 (see FIG. 6) of the comparative example 1. Thus, while keeping the taper angle θ (see FIG. 2) of the tapering surface portion 65 of the measuring surface 62 of the valve body 60 same as the taper angle θ1 (see FIG. 6), the outer diameter of the small-diameter surface portion 63 of the measuring surface 62 can be decreased to d2 (see FIG. 2) in order to increase the minimum flow rate. An axial length of the large-diameter surface portion 64 of the measuring surface 62 of the valve body 60 can be equal to an axial length of the comparative example 1 (see FIG. 6).

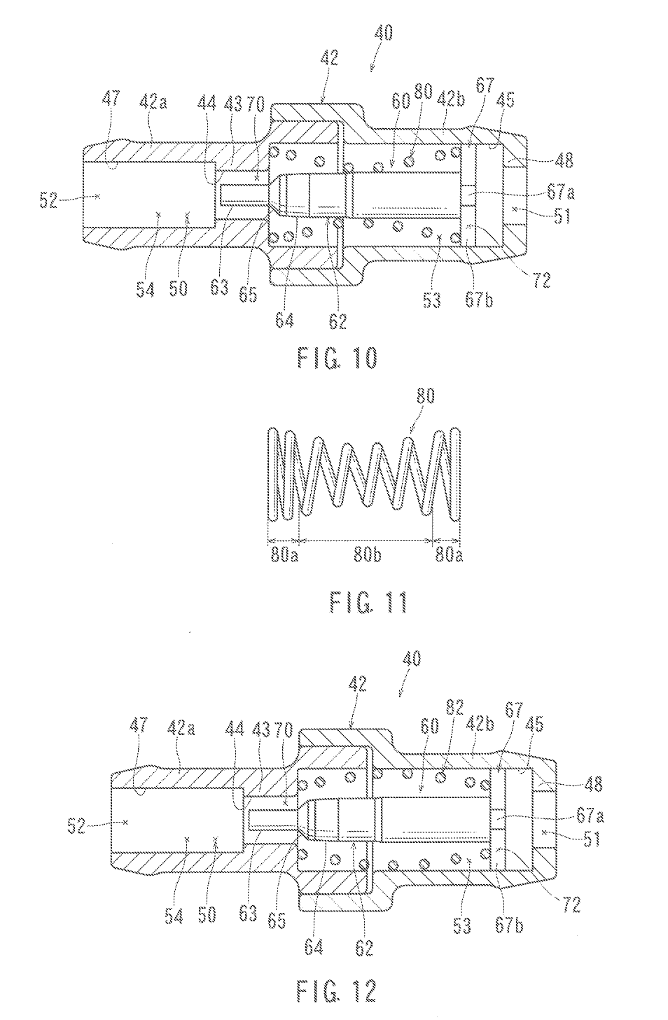

A second embodiment will be described. In this embodiment, the coil spring 74 of the first embodiment is changed, so that such change will be described and the same parts will not be explained. FIG. 10 is a cross-sectional view of a PCV valve. FIG. 11 is a side view of a coil spring. As shown in FIG. 10, in this embodiment, an hourglass-shaped coil spring 80 (see FIG 11) is used instead of the coil spring 74 of the first embodiment (see FIGS. 1 and 3). The hourglass-shaped coil spring 80 has a lower spring constant at wire regions of both ends (first areas 80a) than a wire region of a center area (second area 80b). The hourglass-shaped coil spring 80 has the same shape at both front and rear ends, so that it can be located oppositely in the case 42.

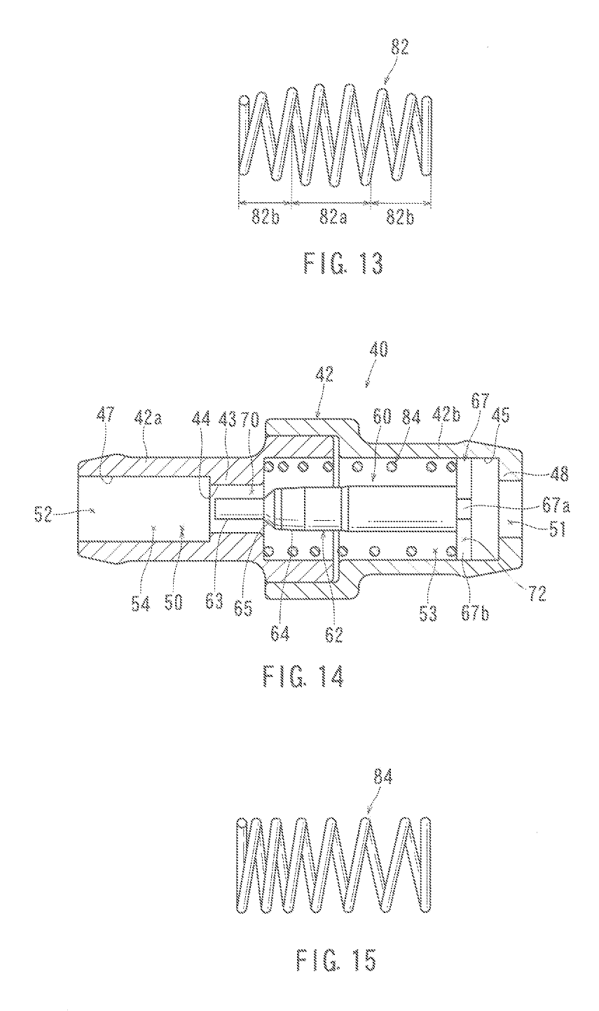

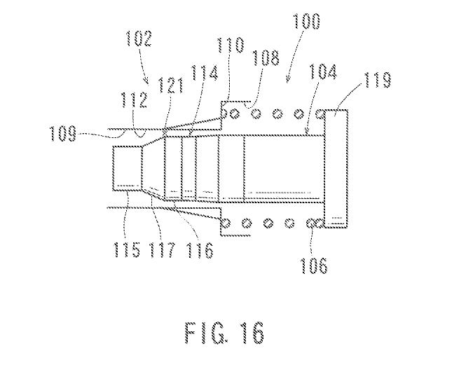

A third embodiment will be described. In this embodiment, the coil spring 74 of the first embodiment is changed, so that such change will be described and the same parts will not be explained. FIG. 12 is a cross-sectional view of a PCV valve. FIG. 13 is a side view of a coil spring. As shown in FIG. 12, in this embodiment, a barrel-shaped coil spring 82 (see FIG. 13) is used instead of the coil spring 74 of the first embodiment (see FIGS. 1 and 3). The barrel-shaped coil spring 82 has a lower spring constant at a wire region of a center area (first area 82a) than wire regions of both ends (second areas 82b). The barrel-shaped coil spring 82 has the same shape at both front and rear ends, so that it can be located opposite of the case 42.

A fourth embodiment will be described. In this embodiment, since the coil spring 74 of the first embodiment is changed, such change will be described and the same parts will not be described. FIG. 14 is a cross-sectional view of a PCV valve. FIG. 15 is a side view of a coil spring. As shown in FIG. 14, in this embodiment, a coil spring having a gradually changing cylinder-shaped pitch 84 (see FIG. 15) is used instead of the coil spring 74 of the first embodiment (see FIGS. 1 and 3). In the coil spring having a gradually changing cylinder-shaped pitch 84, pitches between wires gradually becomes narrow from a rear end toward a front end, so that its coil constant gradually becomes smaller from the rear end toward, the front end. The coil spring having a gradually changing cylinder-shaped pitch 84 is a coil spring having non-linear characteristics that its spring constant continuously becomes larger when the amount of compression becomes larger.

This disclosure is not limited to the described embodiments. For example, this disclosure is not limited to the PCV valve 40 and can be applied to other flow control valves configured to control fluid other than blow-by gas. In addition, the case 42 and/or the valve body 60 is/are not limited to resin products and can be made from metal material.

1. A flow control valve comprising:
a casing having an inlet and an outlet;
a valve body housed in the casing, the valve body being movable in an axial direction; and
a coil spring biasing the valve body toward the inlet;
wherein the casing has a measuring portion therein;
the valve body has at its front end of an outer circumference, a measuring surface to be inserted into the measuring portion;
the measuring surface of the valve body has a small-diameter surface portion at a front end side, a large-diameter surface portion at a base end side and a tapering surface portion connecting the small-diameter surface portion with the large-diameter surface portion;
the valve body moves depending on pressure differences between an inlet side and an outlet side in order to control a flow rate of a fluid flowing through a space between the measuring portion of the casing and the measuring surface of the valve body; and
a spring constant of the coil spring has non-linear characteristics becoming larger in a stepped manner or a continuous manner in accordance with an increase of the compression amount.

2. The flow control valve according to claim 1
wherein the coil spring has at least two-phased non-linear characteristics;
the coil spring has a smaller coil spring constant region corresponding to the movement stroke of a front end portion including the tapering surface portion of the measuring surface of the valve body against the measuring portion of the casing.

3. The flow control valve according to claim 1,
wherein the coil spring is composed of one of a cylinder-shaped irregular pitch coil spring, an hourglass-shaped coil spring and a barrel-shaped coil spring.

4. The flow control valve according to claim 1,
wherein the coil spring is composed of a coil spring having a gradually changing cylinder-shaped pitch whose spring constant continuously changes.
